(19) United States
(12) Patent Application Publication
(10) Pub. No.: US 2025/0209348 A1
(43) Pub. Date: Jun. 26, 2025

(54) Intelligent Virtual Assistant For Conversing With Multiple Users

(71) Applicant: Oracle International Corporation, Redwood Shores, CA (US)

(72) Inventor: Karthik Kothandaraman, Fremont, CA (US)

(73) Assignee: Oracle International Corporation, Redwood Shores, CA (US)

(21) Appl. No.: 18/390,485

(22) Filed: Dec. 20, 2023

(51) Int. Cl. G06N 5/022; G06F 40/35; H04L 51/02

(52) U.S. Cl. CPC G06N 5/022; G06F 40/35; H04L 51/02

(57) ABSTRACT

A virtual assistant may engage in a first conversation with a target user. Based on the first conversation, the virtual assistant may identify a need for a set of information to be provided to the target user. Upon determining that the set of information cannot be obtained from a knowledge base that is accessible to the virtual assistant, the virtual assistant may initiate a second conversation with an informed user. The virtual assistant may request the set of information from the informed user. The request directed to the informed user may be different from a request received by the virtual assistant from the target user in the first conversation. Upon receiving the set of information, the virtual assistant may alter the set of information. The virtual assistant may subsequently provide the set of information to the target user.

### TECHNICAL FIELD

The present disclosure relates to virtual assistants. In particular, the present disclosure relates to an intelligent virtual assistant that may engage in multiple conversations with multiple users.

### BACKGROUND

An entity may need to communicate with a set of other entities. As an example, consider an entity that presents an opportunity. The opportunity may be an advertised employment role, a product or service being offered by the entity, attendance for an event promoted by the entity, a regulative approval process administered by the entity, or a venture proposed by the entity. Potential candidates for the opportunity may have questions about the opportunity, and the entity may be able to attract more quality candidates by answering the questions that the potential candidates may have. Additionally, the entity may wish to direct a question to a candidate or otherwise communicate with the candidate prior to engaging in more advanced discussions with the candidate.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for responding to a query in accordance with one or more embodiments;

FIG. 3 illustrates an example set of operations for formulating a communication in accordance with one or more embodiments;

FIG. 4 illustrates an example set of operations for conversing with users in accordance with one or more embodiments; and

FIG. 5 illustrates a block diagram of a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. SYSTEM ARCHITECTURE
3. RESPONDING TO A QUERY
4. FORMULATING A COMMUNICATION
5. EXAMPLE EMBODIMENT
6. COMPUTER NETWORKS AND CLOUD NETWORKS
7. MICROSERVICE APPLICATIONS
   7.1 TRIGGERS
   7.2 ACTIONS
8. HARDWARE OVERVIEW
9. MISCELLANEOUS; EXTENSIONS

### 1. GENERAL OVERVIEW

One or more embodiments include a virtual assistant that engages in a conversation with a user to obtain a set of information that is to produce an appropriate response to a query that is received from another user. The user submitting the query to the virtual assistant is referred to herein as the target user. The user providing the set of information is referred to herein as the informed user.

One or more embodiments identify a need for a set of information based on a conversation with a target user of the system. For example, a set of information may be needed to produce an appropriate response to a query that is received by the system in the course of a conversation with a target user. If the set of information cannot be determined from a knowledge base that is accessible to the system, the system initiates another conversation with an informed user. The system may initiate the conversation with the informed user after identifying the informed user as a potential source for the set of information. The system may direct a communication to the informed user that requests the set of information. The communication that the system directs to the informed user may be different than the query received from the target user. If the set of information is obtained from a knowledge base and/or from the informed user, the system may produce the appropriate response to the query from the target user. The appropriate response to the query may be a natural language communication that is formulated by the system to include the set of information. If the communication includes the set of information, the set of information may be altered prior to its inclusion in the communication. Additionally, or alternatively, the appropriate response to the query may be a communication that is formulated based on the set of information but does not necessarily include the set of information. For instance, the set of information may be the basis for a determination, calculation, and/or other computation that is required to produce the communication.

In an embodiment, the system may preserve the anonymity of a target user when conversing with an informed user. For example, a target user who directs a query to the system may request that the system not reveal that the target user is the author of the query. The system may maintain the anonymity of the target user in a subsequent conversation with an informed user that is initiated by the system to obtain a set of information needed to produce an appropriate response to the query.

In an embodiment, a communication may be formulated subject to an information distribution rule(s). For example, an information distribution rule may apply to a set of information that is identified by the system as being necessary to produce an appropriate response to a query. Based on the information distribution rule, the system may determine what, if any, information from the set of information is permissible to include in a response to the query.

In an embodiment, a communication directed to an informed user may be a request for information that can be used to respond to multiple queries received by the system. For example, the system may receive two queries from two target users, respectively. A set of information that is needed to produce an appropriate response to one query may overlap with a set of information that is needed to produce an appropriate response to the other query. Further, it may be that neither set of information can be determined from an accessible knowledge base. In this example, the system may formulate a communication directed to an informed user, that is an interrogative designed to elicit both sets of information.

In an embodiment, a communication directed to an informed user may be a request for information that can be used to respond to queries predicted to be received by the system in the future. For example, if a particular set of information is needed to produce an appropriate response to a query received from a target user, the system may direct a communication to an informed user that is formulated to elicit a set of information that is more general than the particular set of information. The general set of information may be utilized to produce a response to the query received from the target user and/or to produce another response to another query(s) that may be received by the system in the future.

In an embodiment, the system may delay initiating a conversation with an informed user based on a batch transmission criterion. For example, a batch transmission criterion may dictate that a system should not initiate a conversation with an informed user until there is an accumulation of a certain number of communications that are to be transmitted to the informed user. When the certain number of communications accumulates, the system may transmit multiple communications to the informed user in a single conversation.

In an embodiment, a system may utilize a generative artificial intelligence (AI) model(s) to formulate a communication. In an example, a generative AI model may be prompted to formulate a communication based on a query that is received by the system. The prompt may include contextual information that is relevant to formulating the communication. The contextual information may be obtained from the knowledge base, obtained from recent conversation history, obtained from subsequently initiated conversations, obtained from other sources, and/or written by the system. The prompt may be input to a generative AI model, and the generative AI model may output a communication based on the prompt. If an initial output from the generative AI model is inadequate, the system may generate a new prompt for the generative AI model. Newly generated prompts may be recursively input to the generative AI model until an adequate output is obtained.

In an embodiment, contextual information may be stored in a knowledge base. The system may add information to the knowledge base. Information added to the knowledge base may include information obtained from conversations with users, information obtained from other documents acquired by the system, information that is written by the system, and/or other information. The contents of a knowledge base may be indexed. The contents of a knowledge base may be organized into multiple separate indexes. Two or more sets of information may be identified in the same index based on the two or more sets of information being related. For example, sets of information that are received from a particular user may be identified in the same index. In another example, sets of information that pertain to the same subject may be identified in the same index. A set of information stored in a knowledge base may be identified by a vector embedding that represents the set of information. Contextual information stored in a knowledge base may be located based on information determined from a conversation with a user. For example, if, in the course of a conversation with a user, a query is received by the system, the system may generate a query vector embedding that represents information determined from the conversation. The system may determine that a set of information located in a knowledge base is contextual information by comparing the query vector embedding to a vector embedding that represents the set of information. The system may expediently obtain contextual information by comparing a query vector embedding to the vector embeddings of indexes that the system determines are likely to contain contextual information. The system may generate a dynamic index that identifies a set(s) of contextual information. A dynamic index may identify multiple sets of information located in multiple indexes of a knowledge base. A set of information identified in a dynamic index may be included in a prompt that is input to a generative AI model.

One or more embodiments described in this Specification and/or recited in the claims may not be included in this General Overview section.

### 2. SYSTEM ARCHITECTURE

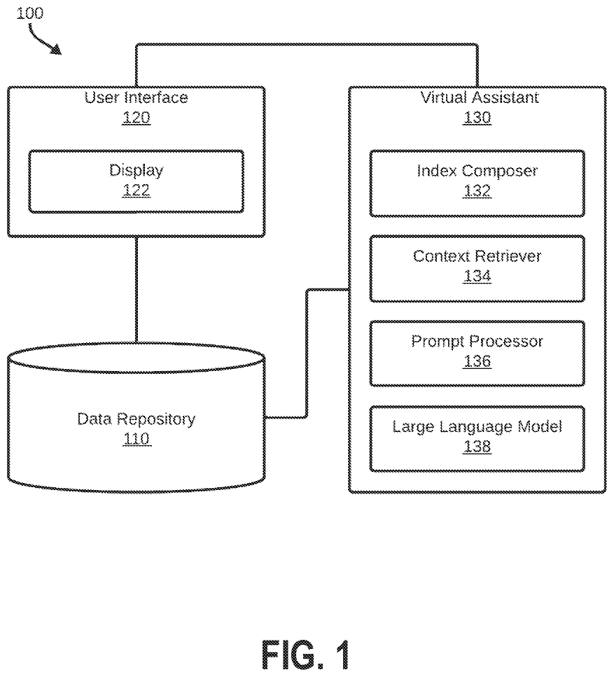

FIG. 1 illustrates a system 100 in accordance with one or more embodiments. As illustrated in FIG. 1, system 100 may include data repository 110, user interface 120, virtual assistant 130, and/or other components.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

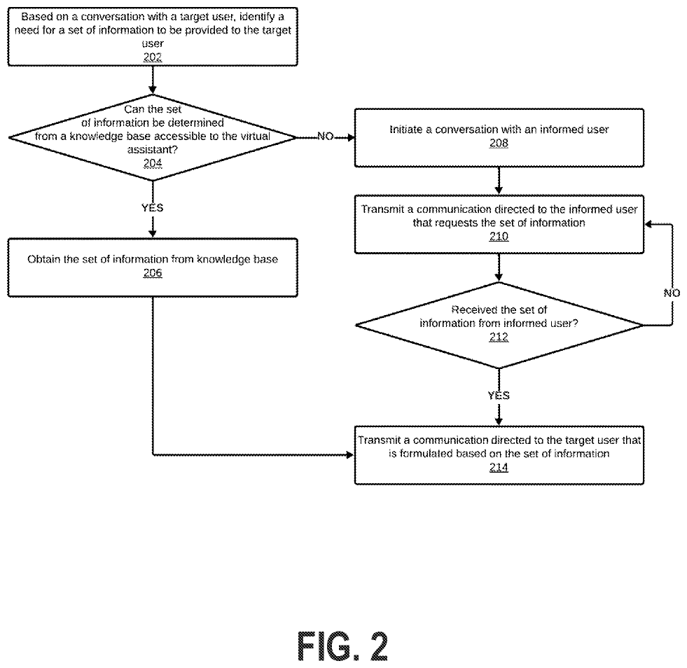

In one or more embodiments, system 100 refers to hardware and/or software configured to perform operations described herein for responding to a query. A query is any occurrence that may result in a response by system 100. In an example, a query may be a natural language user input that requests a set of information. However, it should be understood that a query for a set of information, in the form of a natural language input or otherwise, may not be phrased as an interrogative. Further, it should also be understood that a query for a set of information may not identify the set of information. Examples of operations for responding to a query received by system 100 are described below with reference to FIG. 2.

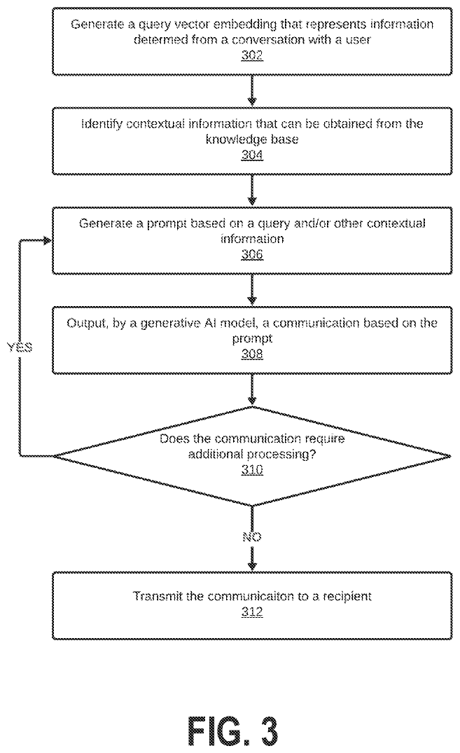

In one or more embodiments, system 100 may refer to hardware and/or software configured to perform operations described herein for formulating a communication. Examples of operations for formulating a communication are described below with reference to FIG. 3.

In one or more embodiments, a data repository 110 is any type of storage unit and/or device (e.g., a file system, database, collection of tables, or any other storage mechanism) for storing data. Further, data repository 110 may include multiple different storage units and/or devices. The multiple different storage units and/or devices may or may not be of the same type or located at the same physical site. Further, a data repository 110 may be implemented or executed on the same computing system as user interface 120 and/or virtual assistant 130. Alternatively, or additionally, a data repository 110 may be implemented or executed on a computing system separate from user interface 120 and/or virtual assistant 130. The data repository 110 may be communicatively coupled to user interface 120 and/or virtual assistant 130 via a direct connection or via a network. In an embodiment, data repository 110 may include a vector database(s).

Information described as being stored within data repository 110 may be implemented across any of the components within the system 100. However, this information may be described as being stored within the data repository 110 for purposes of clarity and explanation.

In an embodiment, data repository 110 may include information generated by system 100, information obtained from a user of system 100, and/or information obtained from other sources. Information stored in data repository 110 may include contextual information. Contextual information is any information that may be relevant to formulating a communication. Contextual information may include a set of information that is needed to produce an appropriate response to a query and/or other sets of information. A set of information stored in data repository 110 may be indexed. Indexing the contents of data repository 110 may allow for the expedient retrieval of information. Two or more sets of information may be identified in the same index based on the two or more sets of information being related. A set of information may be identified in an index by a vector embedding that represents the set of information. An index may also include metadata. Metadata of an index may characterize the contents of the index.

In an embodiment, data repository 110 may store a knowledge base. Additionally, or alternatively, a knowledge base may be stored in an external data repository that is accessible to system 100. A knowledge base may include text data and/or other types of data. Text data may be obtained from a document and/or other sources. A document is any data set from which text data may be obtained. Examples of documents include a conversation with a user, other documents acquired by system 100 (e.g., a product advertisement, a job listing, a resume, etc.), other documents written by system 100, and many others. Text data obtained by system 100 may be broken into text nodes. A text node may be identified in an index of a knowledge base by a vector embedding that represents the text node. Text nodes may be separated into multiple indexes. An index may contain vector embeddings of related text nodes. As an example, consider an entity that is seeking candidates for a role within the entity. If system 100 receives a query from a candidate, there may be multiple indexes of a knowledge base that identify a set of information that is potentially relevant to the query. In this example, information obtained from the candidate may be identified in a first index. For instance, the first index might include vector embeddings representing text nodes obtained from a conversation(s) with the candidate and/or other documents received from the candidate (e.g., a resume, cover letter, completed application forms, etc.). Information obtained from documents produced by the entity may be identified in a second index. For instance, the second index might include vector embeddings representing text nodes obtained from advertisements for the role, documents describing required qualifications for the role, and/or other documents that pertain to the role. Information obtained from representatives of the entity may be identified in a third index. For instance, the third index might include vector embeddings of text nodes obtained from a conversation(s) with a hiring manager responsible for reviewing applications for the role. In this example, the three indexes may also include metadata that characterizes the contents of the respective indexes. For instance, the first index might include metadata describing the candidate (e.g., a candidate identification number). The second index might include metadata describing the role (e.g., a job requisition number). The third index might include metadata describing the hiring manager (e.g., an employee identification number, a department identification number, etc.).

In one or more embodiments, user interface 120 refers to hardware and/or software configured to facilitate communications with a user of system 100. User interface 120 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of user interface 120 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, user interface 120 is specified in one or more other languages, such as Java, C, or C++.

As illustrated in FIG. 1, user interface 120 may be associated with a component for presenting information to a user such as display 122. Display 122 may be implemented on a digital device or otherwise. Display 122 may be, for example, a visual device, an audio device, an audiovisual device, etc. Examples of visual devices include monitors, televisions, projectors, and many others.

In an embodiment, user interface 120 may facilitate a conversation. A conversation may be any interaction(s) between system 100, a user(s), and/or other nodes or entities. An example conversation may include a communication(s) directed to a user and/or a user input(s) received by system 100. System 100 may receive user input through user interface 120. A communication may be transmitted to a user by presenting the communication on display 122. A conversation may include natural language transmissions directed to and/or from system 100. User interface 120 may represent multiple user interfaces. For example, a target user (e.g., an individual interested in a product offered on a virtual marketplace) may converse with system 100 via one user interface 120, and an informed user (e.g., another individual who has listed the product for sale) may converse with system 100 via another user interface 120.

In an embodiment, virtual assistant 130 may formulate a communication. Virtual assistant 130 may formulate a natural language communication and/or other communications. A communication formulated by virtual assistant 130 may be transmitted to a user(s) of system 100, other components of system 100, and/or nodes external to system 100. Virtual assistant 130 may initiate a conversation. Additionally, or alternatively, virtual assistant 130 may formulate a communication(s) responsive to a query and/or other occurrences. For example, in response to a query from a user, virtual assistant 130 may formulate a communication that includes and/or is based on a set of information. A communication formulated by virtual assistant 130 may be a request for a set of information.

In an embodiment, virtual assistant 130 may formulate multiple communications directed to multiple users of system 100. For example, while conversing with a target user, system 100 may receive a query. Producing an appropriate response to the query may necessitate a set of information. To obtain the set of information, virtual assistant 130 may initiate another conversation with an informed user.

Additional embodiments and/or examples relating to responding to a query are described below in Section 3, titled “Responding to a Query.”

In an embodiment, virtual assistant 130 may initiate a conversation with an informed user of system 100 responsive to virtual assistant 130 determining that the informed user may be a potential source for a set of information. An informed user may be identified based on characteristics of the informed user, the nature of a query from a target user, user activity of the informed user, user activity of the target user, and/or other inputs. A conversation may be initiated through a variety of mediums. Examples of mediums include email, instant message, text message, messaging applications, and many others. As an example, consider a query regarding an advertised role at an entity. Producing an appropriate response to the query may require a set of information that cannot be obtained from an accessible knowledge base. Consequently, virtual assistant 130 may identify an informed user. In this example, an informed user may be a representative of the entity. The representative of the entity may be identified based on the representative being a hiring manager responsible for reviewing applications for the role. In another example, an informed user may be identified based on the informed user being the individual who will supervise a candidate selected for the role. In yet another example, an informed user may be a candidate for a role and a target user may be a hiring manger. For instance, a hiring manager may query virtual assistant 130 with regard to the candidate(s) for an opportunity. Virtual assistant 130 may identify the candidate(s) to which the query refers and initiate a conversation with the candidate(s) to obtain a set of information that is needed to respond to the hiring manager's query.

In an embodiment, virtual assistant 130 may formulate a communication that preserves the anonymity of a target user of system 100. As an example, consider a candidate for a role at an entity and a representative of the entity that is involved in processing applications for the role. The candidate may wish to ask a question about the role without the representative of the entity being made aware that the candidate is the author of the particular question. For instance, the candidate may wish to anonymously inquire if the role would allow the candidate to work from home. If the candidate is permitted to ask questions anonymously, system 100 may preserve the candidate's anonymity while producing an appropriate response to the query. If virtual assistant 130 needs to converse with the representative to produce an appropriate response to the query from the candidate, virtual assistant 130 may conceal the identity of the candidate when conversing with the representative.

In an embodiment, virtual assistant 130 may formulate a communication subject to a set of information distribution rule(s). An information distribution rule may restrict what information virtual assistant 130 is permitted to disclose to a user. For example, an information distribution rule might dictate that information categorized as “confidential” by a business entity is not to be included in or otherwise be a basis for a communication directed to a user who is not a member of the business entity. In this example, virtual assistant 130 may refrain from relying on a set of information that is categorized as confidential when producing a response to a query received from a target user who is not a member of the entity. Virtual assistant 130 may request approval for the disclosure of a set of information. For example, virtual assistant 130 may determine that a set of information may be subject to an information distribution role. As a result, virtual assistant 130 may request approval from a user to disclose the set of information to another user.

In an embodiment, virtual assistant 130 may formulate a communication based on a subset of a set of information. For example, virtual assistant 130 may identify a set of information that is needed to produce an appropriate response to a query received from a target user. In this example, virtual assistant 130 may determine that a subset of the set of information is prohibited from disclosure to the target user based on a set of information distribution rule(s). Consequently, virtual assistant 130 may formulate a partial response to the query based on another subset of the set of information that is not prohibited from disclosure to the target user.

In an embodiment, a communication formulated by virtual assistant 130 may be based on multiple queries received by system 100. For example, system 100 may receive a query from a target user and another query from another target user. A set of information that is needed to produce an appropriate response to one query may overlap with a set of information that is needed to produce an appropriate response to the other query. Further, it may be that neither set of information can be determined from an accessible knowledge base. In this example, virtual assistant 130 may formulate a communication directed to an informed user that is designed to elicit both sets of information. If system 100 obtains the two sets of information, virtual assistant 130 may formulate two additional communications to respond to the two queries.

In an embodiment, virtual assistant 130 may formulate a communication requesting information that may be used to respond to queries received in the future by the system 100. For example, a particular set of information may be needed to produce an appropriate response to a query received from a target user. System 100 may determine that the particular set of information is a subset of a general set of information. Virtual assistant 130 may formulate a communication that requests the general set of information from an informed user. The general set of information may be utilized to produce a response to the query previously received from the target user and/or to produce a response to one or more other queries that are received by the system 100. As an example, consider a query from a candidate that inquires if a role at an entity would allow the candidate to work from 8 a.m. to 4 p.m. Virtual assistant 130 may direct a communication to a representative of the entity that inquires if the role allows for flexible working hours. Based on the conversation with the representative of the entity, virtual assistant 130 may respond to the query received from the candidate. If system 100 is subsequently queried by another candidate if the role would allow the other candidate to work from 10 a.m. to 6 p.m., virtual assistant 130 may respond to the other candidate based on the previous conversation with the representative of the entity.

In an embodiment, virtual assistant 130 may delay initiating a conversation with a user of system 100 based on a batch transmission criterion. In an example, a batch transmission criterion might dictate that virtual assistant 130 should not initiate a conversation with a particular user until a certain number of communications that are to be transmitted to the particular user have accumulated. Once the certain number of communications accumulates, virtual assistant 130 may direct multiple communications to the particular user in a single conversation.

In an embodiment, virtual assistant 130 may formulate a communication by utilizing a generative AI model paired with retrieval augmented generation (RAG). As illustrated in FIG. 1, virtual assistant 130 may include index composer 132, context retriever 134, prompt processor 136, large language model 138, and/or other components.

In an embodiment, index composer 132 may generate a dynamic index. A dynamic index may identify contextual information and/or other information. A communication may be formulated in response to a query, and contextual information may be identified based on a query vector embedding. For example, if, in the course of a conversation with a user, a query is received by system 100, a query vector embedding may be generated that represents information determined from the conversation and/or other sources. In this example, the query vector embedding might represent conversation history of the conversation, the identity of a participant(s) to the conversation, the subject of the query, the query itself, and/or other information. Index composer 132 may determine that a set of information is contextual information based on a comparison between a query vector embedding and a vector embedding that represents the set of information. In this way, index composer 132 may locate contextual information in a knowledge base and/or other sources. A query vector embedding may not be compared with every vector embedding that represents a set of information of a knowledge base. For example, if a knowledge base is organized into multiple indexes, a query vector embedding may be compared with the vector embedding(s) of an index(es) that index composer 132 determines is likely to identify contextual information. Index composer 132 may determine that an index is likely to identify contextual information based on metadata of the index and/or other inputs. As an example, consider a candidate who queries the system 100 regarding an opportunity offered by an entity. In this example, a query vector embedding might be compared with vector embeddings in multiple indexes of a knowledge base. A first index may be identified based on metadata of the first index that describes the candidate (e.g., an identification number of the candidate). Vector embeddings in the first index might represent sets of information obtained from the candidate (e.g., from a conversation(s) with the candidate, other documents received from the candidate, and/or other documents pertaining to the candidate that are written by system 100). A second index may be identified based on metadata of the second index that describes the opportunity (e.g., a job requisition number). Vector embeddings in the second index might represent sets of information obtained from documents pertaining to the opportunity that are produced by the entity (e.g., a document describing the opportunity). A third index may be identified based on metadata of the third index that describes a representative(s) of the entity (e.g., an employee identification number, a department identification number, etc.). Vector embeddings in the third index might represent sets of information obtained from a conversation(s) with the representative(s) of the entity.

In an embodiment, context retriever 134 may obtain contextual information. Context retriever 134 may obtain information from data repository 110 and/or other data sources. Information obtained by context retriever 134 may include information obtained from a knowledge base and/or information obtained from outside of a knowledge base. Context retriever 134 may obtain from a knowledge base a set of information based on the set of information being identified in a dynamic index generated by index composer 132. Contextual information outside of a knowledge base may include information from a recent and/or on-going conversation(s) that has not yet been indexed to the knowledge base. For example, if system 100 receives a query from a user, context retriever 134 may retrieve contextual information from the conversation from which the query is received. Additionally, or alternatively, context retriever 134 may obtain information from a conversation with another user and/or another data source. For example, if system 100 receives a query from a target user, context retriever 134 may retrieve information from another conversation with an informed user that is initiated by virtual assistant 130 to obtain information required to appropriately respond to the query.

In an embodiment, prompt processor 136 may generate a prompt that may be used as an input to a generative AI model. In an example, prompt processor 136 may prompt a large language model 138 to output a communication that may be directed to a user. Additionally, or alternatively, virtual assistant 130 may incorporate other type(s) of generative AI model(s). A prompt may be generated based on a query received by system 100. A prompt may include contextual information. For example, a prompt may include a set of information needed to produce an appropriate response to a query and/or other contextual information. Contextual information included in a prompt may be written by system 100. Prompt processor 136 may call for information to be written by system 100. In an example, prompt processor 136 may generate a prompt based on a query received by the system 100 and information obtained from a knowledge base. In another example, prompt processor 136 may generate a prompt based on a query received by system 100 and information obtained from outside of a knowledge base. In yet another example, prompt processor 136 may generate a prompt based on a query received by system 100, information obtained from a knowledge base, and information obtained from outside of the knowledge base. Prompt processor 136 may generate a single prompt based on multiple queries received by system 100. For example, prompt processor 136 may generate a single prompt based on multiple queries requesting related information. Prompt processor 136 may generate multiple prompts based on a single query received by the system 100. For example, prompt processor 136 may generate a first prompt based on a query received by the system 100. If a communication output by a generative AI model based on the first prompt is inadequate, prompt processor 136 may generate a second prompt based on the query. Prompt processor 136 may recursively prompt a generative AI model until an adequate communication is formulated.

In an embodiment, large language model 138 may be applied to output a communication. Large language model 138 may output a communication based on a prompt generated by prompt processor 136 and/or other inputs. A communication output by large language model 138 may be an interrogative communication, a declarative communication, and/or other types of communications. A communication output by large language model 138 may be transmitted to a user, another component, and/or other recipients. In an example, a communication output by large language model 138 is transmitted to a target user. In another example, a communication output by large language model 138 is transmitted to an informed user. Additionally, or alternatively, a communication output by large language model 138 may be stored in data repository 110 and/or another data repository.

A machine learning algorithm is an algorithm that can be iterated to learn a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the accuracy of the current target model f. Updated training data is fed back into the machine learning algorithm, which in turn updates the target model f.

A machine learning algorithm generates a target model f such that the target model f best fits the datasets of training data to the labels of the training data. Additionally or alternatively, a machine learning algorithm generates a target model f such that when the target model f is applied to the datasets of the training data, a maximum number of results determined by the target model/matches the labels of the training data. Different target models be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging, and random forest, boosting, backpropagation, and/or clustering.

In an embodiment, system 100 may apply a machine learning model to predict a set of information that will need to be provided to a user of system 100. In an example, the machine learning model may predict that a set of information will be needed to produce an appropriate response to a query that is likely to be received by system 100. The machine learning model may be trained with sets of training data. Training data may be obtained from a knowledge base and/or other sources. Training data may include historical data obtained from users and/or other data. In an example, a set of training data may include a document(s) pertaining to an opportunity (e.g., an advertisement for a role at an entity), a query(s) received by system 100 regarding the opportunity (e.g., a question from a candidate about the role), and/or other information. Virtual assistant 130 may formulate a communication based on a prediction output by the machine learning model. For example, based on a predicted need for a set of information, virtual assistant 130 may formulate a request to an informed user for the set of information. System 100 may receive feedback pertaining to a prediction output by the machine learning model. Feedback received by system 100 may be used to further train the machine learning model.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a tenant is a corporation, organization, enterprise, or other entity that accesses a shared computing resource. As used herein, an “entity” may refer to a corporation, organization, person, enterprise, and/or other entity.

### 3. RESPONDING TO A QUERY

FIG. 2 illustrates an example set of operations for responding to a query. One or more operations illustrated in FIG. 2 may be modified, rearranged, or omitted all together. Accordingly, the particular sequence of operations illustrated in FIG. 2 should not be construed as limiting the scope of one or more embodiments.

In operation 202, a need for a set of information may be identified. A set of information identified in this operation may be needed to produce an appropriate response to a query. A set of information may need to be included in a response to a query. Additionally, or alternatively, a set of information may be needed to execute a determination, calculation, and/or other computation that is necessary to produce a response to a query. A query may result from a conversation with a user, other user activity, a transmission received from a component external to the system, a computation by the system (e.g., a prediction of a necessary set of information), and/or other occurrences. In an example, a query may result from a conversation between a target user and the system. In this example, it may be that the query is a natural language input requesting a set of information. An appropriate response to the query may be a natural language communication directed to the target user that includes the set of information. A query received from a target user may request that the system not reveal to any other user that the target user is the source of the query. If the target user is permitted to query the system anonymously, the system may conceal the identity of the target user from other users in subsequent operations.

In operation 204, the system may determine if a set of information can be obtained from a knowledge base. The system may proceed to another operation based on the determination. For example, if a set of information identified in an occurrence of operation 202 can be determined from an accessible knowledge base (YES in operation 204), the system may proceed to operation 206. Alternatively, if the set of information cannot be determined from an accessible knowledge base (NO in operation 204), the system may proceed to operation 208.

In operation 206, information may be obtained from a knowledge base. In an example, a set of information identified in an occurrence of operation 202 may be determined from a knowledge base in this operation. Other contextual information may also be determined from the knowledge base.

In operation 208, the system may initiate a conversation with an informed user. The system may initiate a conversation through a variety of mediums. Examples of mediums include email, instant message, text message, messaging applications, and many others. In an example, the system may initiate a conversation with an informed user to obtain a set of information identified in an occurrence of operation 202. The system may initiate the conversation with the informed user responsive to determining that the informed user may be a potential source for the set of information. Prior to initiating a conversation in this operation, the system may determine if any batch transmission criterion is applicable to the informed user. If the informed user is subject to a batch transmission criterion, the system may delay initiating a conversation with the informed user until the batch transmission criterion is satisfied. If a conversation is initiated in this operation based on a query received from a target user, the system may not reveal the identity of the target user during the course of the conversation.

In operation 210, a communication may be transmitted to an informed user. A communication may be transmitted to an informed user by presenting the communication on a display of a user interface. In an example, a communication may be transmitted to an informed user that requests a set of information identified in an occurrence of operation 202. The communication that is directed to the informed user may be different than a query received from a target user. Multiple communications may be transmitted in this operation. For example, if a batch transmission criterion is applicable, multiple communications may be directed to an informed user in this operation. A communication transmitted in this operation may be formulated based on multiple queries received by the system. For example, a single communication transmitted in this operation may be formulated to elicit a first set of information that can be used to respond to a first query and a second set of information that can be used to respond to a second query. A communication transmitted in this operation may be formulated to elicit more information than is needed to respond to a particular query. For example, a communication transmitted in this operation may be formulated to elicit a set of information that is broader and/or more general than a set of information that is identified in an occurrence of operation 202.

Additional embodiments and/or examples relating to formulating a communication are described below in Section 4, titled “Formulating a Communication.”

In operation 212, the system may proceed to another operation based on receiving user input. For example, if user input is received that includes a set of information identified in an occurrence of operation 202 (YES in operation 212), the system may proceed to operation 214. Alternatively, if the set of information is not received (NO in operation 212), the system may return to operation 210. That is, the system may formulate another communication directed to an informed user that is designed to elicit the set information. In another example, if the set of information is not received, the system may return to operation 208. That is, the system may initiate a conversation with another informed user. In this example, the system may initiate the conversation with the other informed user based on identifying the other informed user as a potential source for the set of information. In yet another example, if the set of information is not received, the system may proceed to operation 214. That is, the system may formulate a communication to the target user that is not based on the set of information. For instance, the system may formulate a communication directed to the target user that indicates the system is not able to produce the appropriate response to the query from the target user.

In operation 214, a communication may be transmitted to a user. A communication may be transmitted to a user by presenting the communication on a display of a user interface. In an example, a communication may be transmitted to a target user in this operation. The communication directed to the target user may be formulated based on a set of information obtained in an occurrence of operation 206 or operation 212. The communication may also be formulated based on other contextual information. The communication may be different than user input received by the system in an occurrence of operation 214. The set of information may be included in the communication. If the set of information is included in the communication, the set of information may be altered prior to its inclusion in the communication. Prior to formulating a communication that is to be transmitted in this operation, the system may determine if any information that is a basis for formulating the communication is or may be subject to a set of information distribution rule(s). If a set of information is or may be subject to an information distribution rule, the system may refrain from disclosing the set of information, alert a user, and/or request authorization for disclosing the set of information. If a set of information distribution rule(s) prohibits the disclosure of a subset of a set of information, a communication transmitted in this operation may be formulated based on another subset of the set of information to which the set of information distribution rule(s) does not apply.

Additional embodiments and/or examples relating to formulating a communication are described below in Section 4, titled “Formulating a Communication.”

### 4. FORMULATING A COMMUNICATION

FIG. 3 illustrates an example set of operations for formulating a communication. One or more operations illustrated in FIG. 3 may be modified, rearranged, or omitted all together. Accordingly, the particular sequence of operations illustrated in FIG. 3 should not be construed as limiting the scope of one or more embodiments.

In operation 302, the system may generate a vector embedding. A vector embedding generated in this operation may be a query vector embedding. A query vector embedding may represent information determined based on a conversation with a user and/or other information. Consider, for example, a query that is received from a target user. In this example, the query may be a natural language input that is received by the system in the course of a conversation with the target user. The system may generate a query vector embedding that represents information that was determined based on the conversation with the target user. For instance, the query vector embedding might represent a conversation history of the conversation with the target user, the identity of the target user, the subject of the query, the query itself, and/or other information.

In operation 304, contextual information within a knowledge base may be located. Contextual information located by the system may be identified in a dynamic index that is generated in this operation. The system may determine that a set of information is contextual information based on a comparison between a query vector embedding and a vector embedding that represents the set of information. The system may locate multiple sets of contextual information in this operation. A query vector embedding may not be compared with every vector embedding that represents a set of information of a knowledge base. For instance, vector embeddings that represent sets of information within the knowledge base may be organized into multiple indexes. Two or more vector embeddings may be included in the same index based on the vector embeddings representing sets of information that are related. A query vector embedding may be compared to the vector embedding(s) of an index that the system determines is likely to identify contextual information. The system may determine that an index is likely to identify contextual information based on metadata of the index and/or other inputs. As an example, consider a target user who queries the system regarding an opportunity offered by an entity. A query vector embedding may be compared to: vector embeddings in a first index that represent sets of information obtained from the target user (e.g., from a conversation(s) with the target, other documents received from the target user, and/or other documents pertaining to the target user that are written by the system); vector embeddings in a second index that represent sets of information obtained from documents pertaining to the opportunity that are produced by the entity (e.g., a document describing the opportunity); and vector embeddings in a third index that represent sets of information obtained from a conversation(s) with a representative(s) of the entity (e.g., a conversation with an informed user).

In operation 306, the system may generate a prompt to be used as an input to a generative AI model. A generative AI model may be prompted to output a communication. A generative AI model may be prompted to output a request for a set of information, a response to a query received by the system, and/or any other communication. A prompt may be generated based on a query received by the system and/or other inputs. A prompt may include contextual information. For example, a prompt may include a set of information that is needed to produce an appropriate response to a query and/or other contextual information. Contextual information may be obtained from a knowledge base. For example, contextual information identified in a dynamic index may be obtained in this operation. Additionally, or alternatively, contextual information may be obtained from outside of a knowledge base. For example, the system may obtain a set of information that is needed to produce an appropriate response to a query by initiating a conversation with an informed user and requesting that the informed user provide the set of information. In another example, the system may obtain contextual information from recent conversation history with a target user, informed user, and/or other users. In yet another example, the system may write new contextual information. In yet another example, the system may query an external data source for contextual information. In this example, the query to the external data source may be facilitated by an application programming interface (API). The system may include or exclude contextual information from a prompt based on an information distribution rule(s). For example, a virtual assistant may determine that a set of information may be subject to an information distribution rule. As a result, the virtual assistant may refrain from including the set of information in a prompt and/or may request approval to disclose the set of information. A prompt generated in this operation may be based on multiple queries received by the system. For example, a generative AI model may be prompted to output a communication that is designed to elicit multiple sets of information from an informed user. In this example, the multiple sets of information may be needed to produce multiple responses to multiple queries that are received by the system from target user(s) prior to an occurrence of this operation.

In operation 308, a generative AI model may output a communication that can be directed to a user and/or to another recipient. A communication output by the generative AI model may be a request for a set of information, a response to a query received by the system, and/or any other communication. A generative AI model may be a large language model and/or another variety of generative AI model. A communication output in this operation may be generated based on a prompt that is generated in an occurrence of operation 306 and/or other inputs.

In operation 310, the system may proceed to another operation based on whether a communication requires further processing. For example, if a communication output in an occurrence of operation 308 requires additional processing (YES in operation 310), the system may return to operation 306. That is, a new prompt may be generated and input to a generative AI model. In this example, newly retrieved and/or written contextual information may be included in the new prompt. Alternatively, if the communication does not require additional processing (NO in operation 310), the communication may be transmitted to a recipient and/or stored in a data repository of the system.

In operation 312, a communication may be transmitted to a user. For example, a communication may be transmitted to a target user. In another example, a communication may be transmitted to an informed user. The system may transmit a communication to a user by presenting the communication on a display of a user interface. Additionally, or alternatively, a communication may be stored in a data repository.

### 5. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

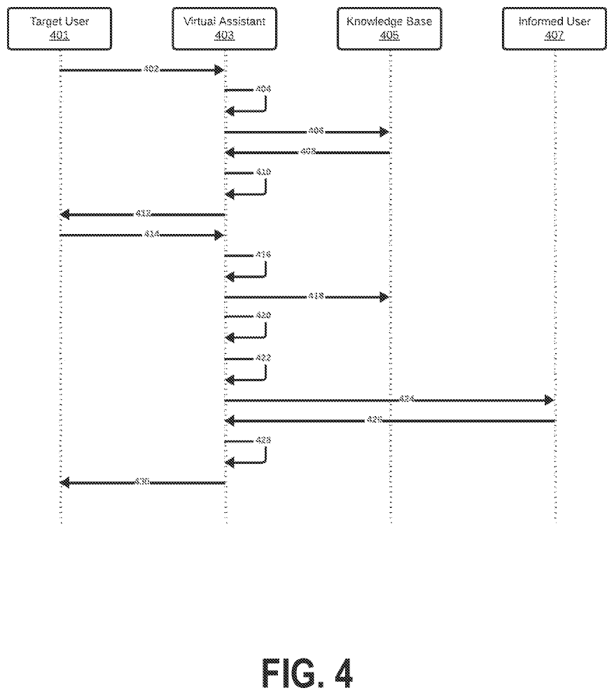

FIG. 4 illustrates an example set of operations for conversing with users. One or more operations illustrated in FIG. 4 may be modified, rearranged, or omitted all together. Accordingly, the particular sequence of operations illustrated in FIG. 4 should not be construed as limiting the scope of one or more embodiments.

In operation 402, the system may receive a query from a user. In this example, the virtual assistant 403 may receive a first query from a target user 401. The first query may be a natural language input that is received via a user interface. The first query may have been received in the course of a conversation with the target user 401. The first query may be a request for a set of information.

In operation 404, the system may identify a need for a set of information. In this example, the virtual assistant 403 may identify a first set of information that is needed to produce an appropriate response to the first query received from the target user 401 in operation 402. It may be that an appropriate response to the first query is a communication directed to the target user 401 that includes the first set of information. Additionally, or alternatively, it may be that an appropriate response to the first query is a communication directed to the target user 401 that is based on the first set of information but does not necessarily include the first set of information. For instance, the set of information may be needed for a determination, calculation, and/or other computation that is required to produce a response.

In operation 406, the system may determine if a set of information can be independently determined by the system. In this example, the virtual assistant 403 may determine that a first set of information identified in operation 404 can be obtained from an accessible knowledge base 405. An accessible knowledge base 405 may be included within a data repository of the system and/or a data repository external to the system. The virtual assistant 403 may determine if a set of information can be obtained from a knowledge base 405 by querying the knowledge base 405 for the set of information. The virtual assistant 403 may query for a set of information based on the set of information being identified in a dynamic index. Additionally, or alternatively, the virtual assistant 403 may query for a set of information that is not identified in a dynamic index.

In operation 408, the system may obtain a set of information. In this example, the virtual assistant 403 may obtain the first set of information identified in operation 404. The virtual assistant 403 may determine the first set of information from the knowledge base 405. The virtual assistant 403 may also obtain other set(s) of contextual information that may be utilized to formulate a response to the first query received in operation 402.

In operation 410, the system may formulate a communication. In this example, virtual assistant 403 may formulate a communication that may be directed to the target user 401. A communication may be formulated by prompting a large language model. The prompt input to the large language model may be generated based on the first query that is received in operation 402. Contextual information may also be included in the prompt such as other information obtained from the conversation with the target user 401, information obtained from the knowledge base 405 (e.g., a set(s) of information identified in a dynamic index), information written by the system, and/or information obtained from another source(s). The prompt may also include the first set of information obtained in operation 408. If the communication includes the first set of information, virtual assistant 403 may alter the first set of information prior to the first set of information being included in the communication.

In operation 412, the system may transmit a communication to a user. In this example, virtual assistant 403 may transmit the communication formulated in operation 410 to the target user 401. The communication may be transmitted to the target user 401 by presenting the communication to the target user 401 on a display of a user interface.

In operation 414, the system may receive a query from a user. In this example, the virtual assistant 403 may receive a second query from the target user 401. The second query may be a natural language input that is received via a user interface. The second query may be a request for a second set of information. The second query may have been received in the course of a conversation with the target user 401. The second query and the first query may be received from the same conversation. Alternatively, the second query and the first query may be received from different conversations.

In operation 416, the system may identify a need for a set of information. In this example, the virtual assistant 403 may identify a second set of information that is needed to produce an appropriate response to the second query received from the target user 401 in operation 414. It may be that an appropriate response to the second query is a communication directed to the target user 401 that includes the second set of information. Additionally, or alternatively, it may be that an appropriate response to the second query is a communication directed to the target user 401 that is based on the second set of information but does not necessarily include the second set of information.

In operation 418, the system may determine if a set of information can be obtained from a knowledge base 405 that is accessible to the system. In this example, the virtual assistant 403 may determine that the second set of information identified in operation 416 cannot be obtained from the knowledge base 405. The virtual assistant 403 may determine that the second set of information cannot be obtained from a knowledge base 405 based on the virtual assistant 403 having queried the knowledge base 405 for the second set of information.

In operation 420, the system may identify a data source that may supply a set of information. In this example, the virtual assistant 403 may identify an informed user 407 as a potential source for the second set of information identified in operation 416. The system may identify the informed user 407 as a potential source of the second set of information based on characteristics of the informed user 407 and/or other inputs.

In operation 422, the system may formulate a communication. In this example, the virtual assistant 403 may formulate a communication that is directed to the informed user 407 identified in operation 420. The communication may be a natural language communication. The communication may be formulated as an interrogative that is designed to elicit the second set of information identified in operation 416. The communication may be formulated by prompting a large language model. The prompt may be generated based on the second query received from the target user 401 in operation 414. The prompt may include contextual information. The contextual information included in the prompt may be obtained from the conversation with the target user 401, the knowledge base 405 (e.g., a set(s) of information identified in a dynamic index), other data sources, and/or written by the system. The communication formulated in this example operation may be different than the second query received from the target user 401. The communication may be formulated such that the communication does not reveal the target user's 401 identity to the informed user 407.

In operation 424, the system may initiate a conversation with a user and transmit a communication to the user. In this example, the virtual assistant 403 may initiate a conversation with the informed user 407 identified in operation 420, and the virtual assistant 403 may transmit to the informed user 407 the communication formulated in operation 422. The communication may be transmitted to the informed user 407 by presenting the communication to the informed user 407 on a display of a user interface.

In operation 426, the system may obtain a set of information. In this example, the virtual assistant 403 may obtain the second set of information identified in operation 416. The virtual assistant 403 may obtain the second set of information in a natural language input that is received from the informed user 407 with whom a conversation is initiated in operation 424.

In operation 428, the system may formulate a communication. In this example, the virtual assistant 403 may formulate a communication that is a response to the second query that is received from the target user 401 in operation 416. The communication may be formulated by prompting a large language model. The prompt may be generated based on the second query. The prompt may include the second set of information obtained in operation 426. Other contextual information may also be included in the prompt, such as information obtained from the conversation with the target user 401, information obtained from the conversation with the informed user 407, information obtained from the knowledge base 405 (e.g., a set(s) of information identified in a dynamic index), information written by the system, and/or information obtained from another source(s). The communication formulated in this operation may be different than the natural language input that is received from the informed user 407 in operation 426. If the communication formulated in this operation includes the second set of information, the virtual assistant 403 may alter the second set of information prior to the second set of information being included in the communication.

In operation 430, the system may transmit a communication to a user. In this example, the virtual assistant 403 may transmit the communication formulated in operation 428 to the target user 401 from whom the second query is received in operation 416. The communication may be transmitted to the target user 401 by presenting the communication to the target user 401 on a display of a user interface.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities; the term “entity” as used herein refers to a corporation, organization, person, enterprise, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset stored by the computer network is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates the tenants that have authorization to access specific applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MICROSERVICE APPLICATIONS

According to one or more embodiments, the techniques described herein are implemented in a microservice architecture. A microservice in this context refers to software logic designed to be independently deployable with endpoints that may be logically coupled to other microservices to build a variety of applications. Applications built using microservices are distinct from monolithic applications that are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) whenever trigger events from a set of trigger events exposed to the microservices manager occur. Microservices exposed for an application may additionally or alternatively provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### 7.1 Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values and/or absolute or relative thresholds for the amount or duration of data to analyze such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or the trigger outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 7.2 Actions

In one or more embodiments, a plugged-in microservice application may expose actions to the microservices manager. The exposed actions may receive, as input, data or an identification of a data object or location of data that causes data to be moved into a data cloud.

In one or more embodiments, the exposed actions may receive, as input, a request to increase or decrease existing alert thresholds. The input might identify existing in-application alert thresholds and whether to increase, decrease, or delete the threshold. Additionally, or alternatively, the input might request the microservice application to create new. in-application alert thresholds. The in-application alerts may trigger alerts to the user while logged into the application, or they may trigger alerts to the user using default or user-selected alert mechanisms available within the microservice application itself rather than through other applications plugged into the microservices manager.

In one or more embodiments, the microservice application may generate and provide an output based on input that identifies, locates, or provides historical data and defines the extent or scope of the requested output. The action, when triggered, causes the microservice application to provide, store, or display the output, for example, as a data model or as aggregate data that describes a data model.

### 8. HARDWARE OVERVIEW

According to one embodiment, the techniques described herein are implemented by one or more special-purpose computing devices. The special-purpose computing devices may be hard-wired to perform the techniques, or they may include digital electronic devices, such as one or more application-specific integrated circuits (ASICs), field programmable gate arrays (FPGAs), or network processing units (NPUs) that are persistently programmed to perform the techniques. The special-purpose computing devices may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

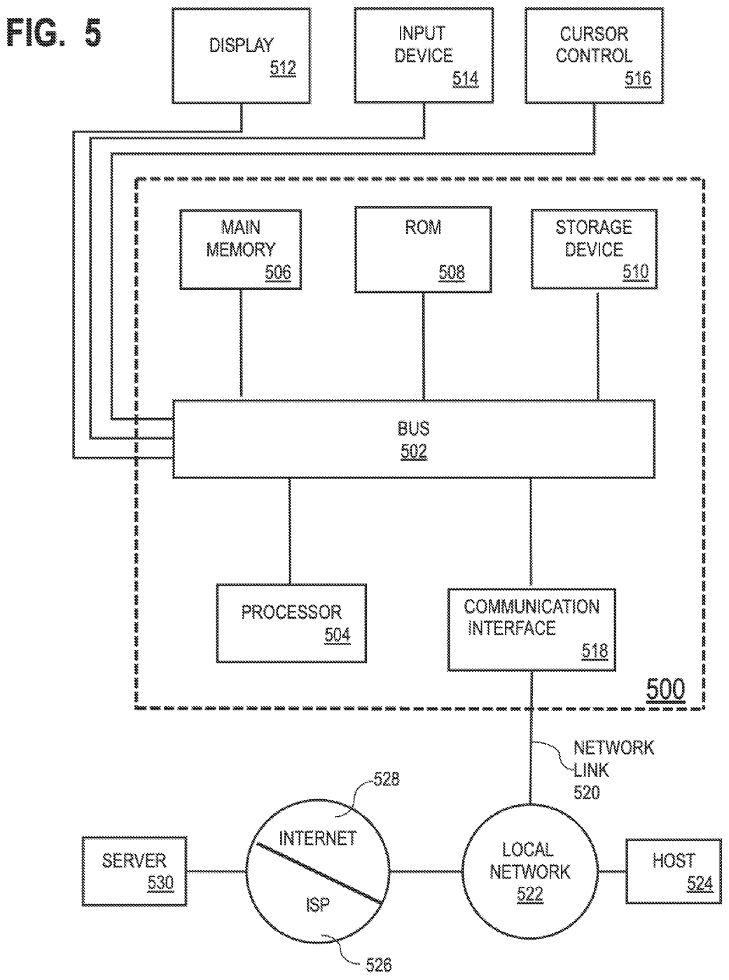

For example, FIG. 5 is a block diagram that illustrates a computer system 500 upon which an embodiment of the disclosure may be implemented. Computer system 500 includes a bus 502 or other communication mechanism for communicating information and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512 such as a cathode ray tube (CRT) for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allow the device to specify positions in a plane.

Computer system 500 may implement the techniques described herein using customized hard-wired logic, one or more ASICs or FPGAs, firmware and/or program logic that in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium such as storage device 510. Execution of the sequences of instructions contained in main memory 506 causes processor 504 to perform the process steps described herein. In alternative embodiments, hard-wired circuitry may be used in place of, or in combination with, software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with: patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506 from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518 that carries the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522, and communication interface 518.

The received code may be executed by processor 504 as it is received and/or stored in storage device 510 or other non-volatile storage for later execution.

### 9. MISCELLANEOUS; EXTENSIONS

Unless otherwise defined, all terms (including technical and scientific terms) are to be given their ordinary and customary meaning to a person of ordinary skill in the art, and all terms are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. Accordingly, the specification and drawings are to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
executing, by a virtual assistant, a first conversation with a first human user;
identifying, by the virtual assistant based on the first conversation, a need for a first set of information to be provided to the first human user;
determining, by the virtual assistant, that the first set of information cannot be determined from a knowledge base accessible to the virtual assistant;
responsive to (a) identifying the need for the first set of information and (b) determining that the first set of information cannot be determined from the knowledge base:
requesting, by the virtual assistant in a second conversation with a second human user, the first set of information to be provided to the first human user;
receiving, by the virtual assistant, the first set of information from the second human user via the second conversation;
presenting, by the virtual assistant, the first set of information to the first human user via the first conversation or a third conversation with the first human user; and
wherein the virtual assistant executes a derivation process comprising at least one of:
requesting the first set of information at least by formulating and transmitting a information request that is different from and based on an information request received from the first human user via the first conversation, and/or
modifying the first set of information prior to presenting the first set of information to the first human user.

2. The one or more non-transitory computer-readable media of claim 1, wherein prior to requesting the first set of information in the second conversation, the operations further comprise:
initiating, by the virtual assistant, the second conversation with the second human user in response to (a) identifying the need for the first set of information and (b) determining that the first set of information cannot be determined from the knowledge base.

3. The one or more non-transitory computer-readable media of claim 1, wherein the operations further comprise:
receiving, by the virtual assistant from the first human user during the first conversation, a request to obtain the first set of information without identifying the first human user to any other user that may be providing the first set of information;
wherein the virtual assistant requests the first set of information in the second conversation without identifying the first human user based on the request from the first human user.

4. The one or more non-transitory computer-readable media of claim 1, wherein the operations further comprise:
receiving, by the virtual assistant, a set of information distribution rules corresponding to the first set of information received from the second human user;
determining, by the virtual assistant based on the set of information distribution rules, that the virtual assistant is permitted to share the first set of information with the first human user,
wherein the virtual assistant presents the first set of information to the first human user based at least in part on determining that the virtual assistant is permitted to share the first set of information with the first human user.

5. The one or more non-transitory computer-readable media of claim 1, wherein the operations further comprise:
receiving, by the virtual assistant, a set of information distribution rules corresponding to the first set of information received from the second human user;
determining, by the virtual assistant based on the set of information distribution rules, that the virtual assistant is permitted to share a first subset of the first set of information with a third human user and not permitted to share a second subset of the first set of information with the third human user,
presenting, by the virtual assistant to the third human user, the first subset of the first set of information received from the second human user without presenting the second subset of the first set of information; and
wherein the virtual assistant presents the first set of information to the first human user based at least in part on determining that the virtual assistant is permitted to share the first set of information with the first human user.

6. The one or more non-transitory computer-readable media of claim 1, wherein the operations further comprise:
executing, by the virtual assistant, a fourth conversation with a third human user;
identifying, by the virtual assistant based on the fourth conversation, a need for a second set of information to be provided to the third human user;
based on an overlap between the first set of information and the second set of information: generating, by the virtual assistant, a single question that requests data needed for addressing both the need for the first set of information and the need for the second set of information;
presenting, by the virtual assistant in the second conversation with the second human user, the single question that requests the data;
receiving, by the virtual assistant, the data from the second human user via the second conversation,
wherein the data comprises the first set of information and the second set of information; and
presenting, by the virtual assistant, the second set of information to the third human user via the fourth conversation or a fifth conversation with the third human user.

7. The one or more non-transitory computer-readable media of claim 1, wherein the operations further comprise:
executing, by the virtual assistant, a fourth conversation with a third human user;
identifying, by the virtual assistant based on the fourth conversation, a need for a second set of information to be provided to the third human user;
determining that the second set of information is a subset of a general set of information; and
requesting, by the virtual assistant from the second human user, the general set of information instead of the second set of information.

8. The one or more non-transitory computer-readable media of claim 1, wherein the operations further comprise:
subsequent to identifying the need for the first set of information: delaying, by the virtual assistant, requesting of the first set of information from the second human user until a batch transmission criterion is met;
identifying, by the virtual assistant, a need for a second set of information;
determining based at least on the need for the first set of information and the need for the second set of information, that the batch transmission criterion is met; and
transmitting a batch of requests to the second human user, the batch of requests comprising a first request for the first set of information and a second request for the second set of information.

9. The one or more non-transitory computer-readable media of claim 1, wherein determining the first set of information cannot be determined from a knowledge base accessible to the virtual assistant comprises:
executing a query directed to the knowledge base for the first set of information.

10. The one or more non-transitory computer-readable media of claim 1, wherein the operations further comprise:
prior to determining the that the first set of information cannot be determined from a knowledge base accessible to the virtual assistant:
identifying the knowledge base as a potential source for the set of information; and
prior to requesting the first set of information in the second conversation with the second human user:
identifying the second human user as a potential source for the second set of information,
wherein the second human user is identified based at least in part on a characteristic of the second human user.

11. The one or more non-transitory computer-readable media of claim 1, wherein the knowledge base is organized into one or more indexes, wherein a set of information of the knowledge base may be identified in an index by a vector embedding that represents the set of information, and wherein formulating the information request that is different from and based on an information request received from the first human user comprises:
generating a query vector embedding based at least on the first conversation;
identifying a relevant set of information in the knowledge base by comparing the query vector embedding to a vector embedding representing the relevant set of information;
generating a prompt based at least on one of (a) the information request received from the first human user, (b) the relevant set of information, and/or (c) the prior history of the first conversation; and
generating, by a generative AI model based on the prompt, the information request that is different from and based on the information request received from the first human.

12. A method comprising:
executing, by a virtual assistant, a first conversation with a first human user;
identifying, by the virtual assistant based on the first conversation, a need for a first set of information to be provided to the first human user;
determining, by the virtual assistant, that the first set of information cannot be determined from a knowledge base accessible to the virtual assistant;
responsive to (a) identifying the need for the first set of information and (b) determining that the first set of information cannot be determined from the knowledge base:
requesting, by the virtual assistant in a second conversation with a second human user, the first set of information to be provided to the first human user;
receiving, by the virtual assistant, the first set of information from the second human user via the second conversation;
presenting, by the virtual assistant, the first set of information to the first human user via the first conversation or a third conversation with the first human user;
wherein the virtual assistant executes a derivation process comprising at least one of:
requesting the first set of information at least by formulating and transmitting an information request that is different from and based on an information request received from the first human user via the first conversation, and/or
modifying the first set of information prior to presenting the first set of information to the first human user; and
wherein the method is performed by at least one device including a hardware processor.

13. The method of claim 12, further comprising:
initiating, by the virtual assistant, the second conversation with the second human user in response to (a) identifying the need for the first set of information and (b) determining that the first set of information cannot be determined from the knowledge base.

14. The method of claim 12, further comprising:
receiving, by the virtual assistant from the first human user during the first conversation, a request to obtain the first set of information without identifying the first human user to any other user that may be providing the first set of information;
wherein the virtual assistant requests the first set of information in the second conversation without identifying the first human user based on the request from the first human user.

15. The method of claim 12, further comprising:
receiving, by the virtual assistant, a set of information distribution rules corresponding to the first set of information received from the second human user;
determining, by the virtual assistant based on the set of information distribution rules, that the virtual assistant is permitted to share the first set of information with the first human user,
wherein the virtual assistant presents the first set of information to the first human user based at least in part on determining that the virtual assistant is permitted to share the first set of information with the first human user.

16. The method of claim 12, further comprising
executing, by the virtual assistant, a fourth conversation with a third human user;
identifying, by the virtual assistant based on the fourth conversation, a need for a second set of information to be provided to the third human user;
based on an overlap between the first set of information and the second set of information: generating, by the virtual assistant, a single question that requests data needed for addressing both the need for the first set of information and the need for the second set of information;
presenting, by the virtual assistant in the second conversation with the second human user, the single question that requests the data;
receiving, by the virtual assistant, the data from the second human user via the second conversation,
wherein the data comprises the first set of information and the second set of information;
presenting, by the virtual assistant, the second set of information to the third human user via the fourth conversation or a fifth conversation with the third human user.

17. The method of claim 12, further comprising:
executing, by the virtual assistant, a fourth conversation with a third human user;
identifying, by the virtual assistant based on the fourth conversation, a need for a second set of information to be provided to the third human user;
determining that the second set of information is a subset of a general set of information; and
requesting, by the virtual assistant from the second human user, the general set of information instead of the second set of information.

18. The method of claim 12, further comprising:
subsequent to identifying the need for the first set of information: delaying, by the virtual assistant, requesting of the first set of information from the second human user until a batch transmission criterion is met;
identifying, by the virtual assistant, a need for a second set of information;
determining based at least on the need for the first set of information and the need for the second set of information, that the batch transmission criterion is met;
transmitting a batch of requests to the second human user, the batch of requests comprising a first request for the first set of information and a second request for the second set of information.

19. The method of claim 12, wherein the knowledge base is organized into one or more indexes, wherein a set of information of the knowledge base may be identified in an index by a vector embedding that represents the set of information, and wherein modifying the first set of information prior to presenting the first set of information comprises:
generating a query vector embedding based at least on the first conversation;
identifying a relevant set of information in the knowledge base by comparing the query vector embedding to a vector embedding representing the relevant set of information;
generating a prompt based at least on one of (a) the information request received from the first human user, (b) the relevant set of information, (c) the prior history of the first conversation, and/or (d) the prior history of the second conversation; and
modifying, by the generative AI model based on the prompt, the first set of information.

20. A system comprising:
at least one device including a hardware processor;
the system being configured to perform operations comprising:
executing, by a virtual assistant, a first conversation with a first human user;
identifying, by the virtual assistant based on the first conversation, a need for a first set of information to be provided to the first human user;
determining, by the virtual assistant, that the first set of information cannot be determined from a knowledge base accessible to the virtual assistant;
responsive to (a) identifying the need for the first set of information and (b) determining that the first set of information cannot be determined from the knowledge base:
requesting, by the virtual assistant in a second conversation with a second human user, the first set of information to be provided to the first human user;
receiving, by the virtual assistant, the first set of information from the second human user via the second conversation;
presenting, by the virtual assistant, the first set of information to the first human user via the first conversation or a third conversation with the first human user;
wherein the virtual assistant executes a derivation process comprising at least one of:
requesting the first set of information at least by formulating and transmitting an information request that is different from and based on an information request received from the first human user via the first conversation, and/or
modifying the first set of information prior to presenting the first set of information to the first human user.
